(19) United States
(12) Patent Application Publication
(10) Pub. No.: US 2008/0190939 A1
(43) Pub. Date: Aug. 14, 2008

(54) Combustion Gas Cartridge for Gas Fastening Device

(76) Inventors: Cyril Marion, Valence (FR); Frederic Nayrac, Bourg Les Valence (FR); Pascal Reverchon, Chabeuil (FR); Christian Ricordi, Bourg Les Valence (FR); Jean-Luc Simonin, Barcelonne (FR)

Correspondence Address: LOWE, HAUPTMAN, GILMAN & BERNER, LLP (ITW), 1700 DIAGONAL ROAD, SUITE 300, ALEXANDRIA, VA, 22314, US

(21) Appl. No.: 11/910,087

(22) PCT Filed: Apr. 21, 2006
(86) PCT No.: PCT/IB2006/000971

§ 371 Date: Sep. 28, 2007

(30) Foreign Application Priority Data
Apr. 22, 2005 (FR) 0504054

(51) Int. Cl. F17C 1/00

(52) U.S. Cl. 220/586; 220/619

(57) ABSTRACT

Combustion gas cartridge for a gas internal combustion fastening device, comprising an external casing over which is crimped the edge of an internal cup beyond which an outlet end projects. The external casing is stepped and includes three longitudinal zones having different respective diameters, namely a first edge zone, a second bearing zone for the head of a crimping machine having a smaller diameter than that of the edge zone and a third zone having a diameter equal to or greater than that of the edge zone and forming an annular shoulder together with the second bearing zone for the crimping head.

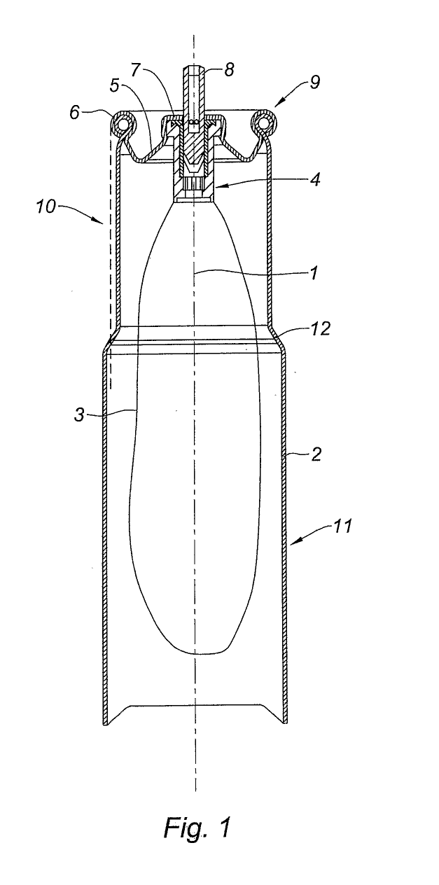

The field of the invention is that of the fastening of elements with the aid of a gas internal combustion device, the combustion gas originating from a cartridge housed in the device and, more particularly, from the gas cartridge itself. Possible fastening devices are nail drivers, hammers and other staplers.

A gas cartridge for a gas fastening device has a general cylindrical shape and is provided in an internal casing with the compressed gas in the liquid state and between the internal casing and an external casing with a propellant. An edge extends around the periphery of a dish or cup forming a continuation of the external cylindrical casing. One end of a gas exhaust mechanism connected to the internal casing projects beyond the cup by means of a base situated in the centre of this cup. The cup is crimped over the external casing of the cartridge by means of its edge on a crimping machine. Once the cup has been crimped over the casing, the external diameter of the cup is consequently greater that that of the external casing of the cartridge at the edge.

As a cartridge is introduced into the housing provided for it in a fastening tool by means of its gas exhaust side, i.e. the side of the cup and of the edge, as a result of its enlarged diameter in relation to the remainder of the cartridge, the cartridge can pivot or tilt slightly once it is in its housing as a result of play. There is therefore a risk that it may not be possible to use all of the combustion gas in the cartridge before it is removed from the device as a result of wear of the seals subjected to stress upon each firing operation.

The aim of this invention is to eliminate this risk.

To this end, the invention relates to a combustion gas cartridge for a gas internal combustion fastening device, comprising an external casing over which is crimped the edge of an internal cup beyond which an outlet end projects, characterised in that the external casing of the cartridge is stepped and includes at least three longitudinal zones having different respective diameters, namely a first edge zone, a second bearing zone for the head of a crimping machine having a smaller diameter than that of the edge zone and a third zone having a diameter equal to or greater than that of the edge zone and forming an annular shoulder together with the second bearing zone for the crimping head.

By virtue of the invention, the propellant content of the cartridge is increased, thereby leading to improved exhaustion of the combustion gas from the internal casing and increasing the efficiency of the cartridge.

The third zone of the casing can be integrated into the casing, i.e. the casing is made in one piece, although this third zone can also be added on to the casing over which the edge is crimped. It can be, e.g. a sleeve, a ring, a seal, a circlip, or a rib. In this respect, the rib could also have been obtained by forming. The casing in question can thus be regarded as the envelope of the cartridge in the mathematical sense.

It will be noted that this third zone having an enlarged section in relation to that of the second zone can have very small longitudinal dimensions, as would be the case with a rib.

It will also be noted that the casing can have at least one other zone having a different section beyond this third zone, even if the advantage of another zone of this kind is not always clear.

The invention will be more readily understood with the aid of the following description of the preferred embodiment of the cartridge of the invention, with reference to the single figure showing a side view thereof.

The gas cartridge which will now be described, intended exclusively for use in a gas internal combustion fastening device, has a general cylindrical shape having an axis 1. It comprises a tubular external casing 2, in this case made in one piece, and an internal casing 3. The internal casing contains a predetermined quantity of compressed gas in the liquid state. The propellant is situated between the two casings.

The cartridge includes a gas exhaust mechanism 4 mounted on a dish or cup 5 and connected to the internal casing 3. The cup 5 is crimped over the external casing 9 and therefore includes a crimping edge 6 around the periphery of the cup 5 forming a continuation of the external casing 2. The gas exhaust mechanism 4, in this case in the centre of the cup, includes an outlet end 8 mounted on a central base 7 of this mechanism, opening into the interior of the internal casing 3 and projecting beyond the cup 5 along the axis 1 of the cartridge.

The cartridge of the invention is characterised in that its external casing 2 is stepped. It includes three longitudinal zones, therefore extending along the axis I of the cartridge, having different respective transverse diameters:
a first zone 9 is that of the crimping edge 6,
a second zone 10 having a smaller diameter that that of the first zone is a zone having served for the crimping of the cup 5 over the external casing 2 on a crimping machine, this zone having served more precisely as a bearing surface for the head of the crimping machine,
a third zone 1I having an enlarged diameter in this case greater than that of the first zone 9 and forming an annular shoulder 12 together with the second zone 10.

A generating line of the zone 9 of the edge has been shown by a dotted line in the figure in order to show the different diameters clearly.

In the case in question, the external casing 2 includes only three zones.

The propellant content of the cartridge has thus been increased in order to result in improved exhaustion of the combustion gas from the cartridge and thereby increase its efficiency.

In addition, the shoulder 12 in this particular case also serves as a stop for the protective cap of the cartridge.

It will be noted that the axial length of the intermediate zone 10 of the external casing 2 under the edge 6 (9) is by no means negligible, of the order of 10 to 60% of the length of the external casing, purely by way of example, and that a cartridge having a shape of this kind is quite original.

Also by way of example, the diameter of the enlarged zone 11 of the external casing 2 of the cartridge can be at most 30% greater than that of the edge 6 when it is not equal thereto. In one particular embodiment of the cartridge, the diameters are respectively 33 mm, 31.5 mm and 35 mm.

1. Combustion gas cartridge for a gas internal combustion fastening device, comprising an external casing over which is crimped the edge of an internal cup beyond which an outlet end projects, characterized in that the external casing of the cartridge is stepped and includes at least three longitudinal zones having different respective diameters, namely a first edge zone, a second bearing zone for the head of a crimping machine having a smaller diameter than that of the edge zone and a third zone having a diameter equal to or greater than that of the edge zone and forming an annular shoulder together with the second bearing zone for the crimping head.

2. Cartridge according to claim 1, in which the third zone is integrated into the external casing.

3. Cartridge according to claim 1, in which the third zone is added on to the external casing.

4. Cartridge according to claim 1, in which the length of the second zone is 10 to 60% of the length of the external casing.

5. Cartridge according to claim 1, in which the diameter of the enlarged zone of the external casing is at most 30% greater than that of the edge.
